(19) United States
(12) Patent Application Publication
(10) Pub. No.: US 2026/0328480 A1
(43) Pub. Date: Oct. 22, 2026

(54) MULTI-ZONE TANK DEVICES, SYSTEMS, AND METHODS

(71) Applicant: Rebound Technologies, Inc., Commerce City, CO (US)

(72) Inventors: Russell Goldfarbmuren, Denver, CO (US); Luke Erickson, Denver, CO (US)

(21) Appl. No.: 19/560,892

(22) Filed: Mar. 9, 2026

Related U.S. Application Data
(63) Continuation of application No. PCT/US24/45780, filed on Sep. 9, 2024.
(60) Provisional application No. 63/537,486, filed on Sep. 9, 2023.

(51) Int. Cl. F28D 1/06

(52) U.S. Cl. CPC F28D 1/06

(57) ABSTRACT

Multi-zone tank devices, systems, and methods are provided in accordance with various embodiments. The multi-zone tank devices, systems, and methods may be applicable to freeze point suppression cycles and other applications. For example, the multi-zone tanks may provide a direct contact recuperator between a freeze point suppression cycle's warm solid, such as ice, and cold dilute brine that may be integrated directly into the multi-zone tank; this integration may be used to solve various challenges such as subcooling the solid that may maximize ice efficiency and reducing the concentration of brine that may maximize cycle efficiency. Multi-zone tanks may include a bottom zone and a top zone, though some embodiments include additional zones.

### CROSS-REFERENCES TO RELATED APPLICATIONS

This application is a non-provisional patent application claiming priority benefit of U.S. provisional patent application Ser. No. 63/537,486, filed on Sep. 9, 2023 and entitled “MULTI-ZONE ICE TANK DEVICES, SYSTEMS, AND METHODS FOR FREEZE POINT SUPPRESSION CYCLES,” the entire disclosure of which is herein incorporated by reference for all purposes.

### BACKGROUND

Heat transfer between different materials may be performed in a variety of ways. Heat exchangers, for example, may be utilized to transfer heat between one or more fluids and/or one or more solids. Heat exchangers may be utilized in a wide variety of technologies such as space heating, refrigeration, and air conditioning. A recuperator may provide a specific type of heat exchanger that may facilitate heat transfer inside a system to increase efficiency, for example.

While some technologies may have the ability to move heat around, such as recuperators, there may be a general need for new tools and techniques for recuperation, in particular, within freeze point suppression cycles.

### SUMMARY

Multi-zone tank devices, systems, and methods are provided in accordance with various embodiments. The multi-zone tank devices, systems, and methods may be applicable to freeze point suppression cycles and other applications. For example, the multi-zone tanks may provide a direct contact recuperator between a freeze point suppression cycle's warm solid (e.g., ice) and cold dilute brine that may be integrated directly into the multi-zone tank; this integration may be used to solve various challenges such as subcooling the ice that may maximize ice efficiency and reducing the concentration of brine that may maximize cycle efficiency. Multi-zone tanks in some embodiments include two or more zones. Some embodiments include a bottom zone and a top zone, though other embodiments include additional zones.

Some embodiments include a method that includes delivering a first brine to a tank. At least a portion of one or more solids may be melted in the tank using the first brine in the tank to form a second brine. The second brine may be removed from the tank; a concentration of the second brine may be lower than a concentration of the first brine and a temperature of the second brine may be lower than a temperature of the first brine. The second brine may be utilized with respect to one or more loads. A third brine may be delivered to the tank; the third brine may be formed from the second brine after the second brine is utilized with respect to the one or more loads; at least a temperature of the third brine may be higher than the temperature of the second brine or a concentration of the third brine may lower than the concentration of the second brine. At least another portion of the one or more solids may be melted using the third brine in the tank to form a fourth brine. The fourth brine from the tank may be removed; a temperature of the fourth brine may be lower than the temperature of the third brine and a concentration of the fourth brine may be lower than a concentration of the third brine.

In some embodiments of the method, the first brine is delivered to the tank through one or more inlet ports for the first brine. The second brine may be removed from the tank using one or more outlet ports for the second brine. The one or more inlet ports for the first brine may be positioned higher in the tank than the one or more outlet ports for the second brine.

In some embodiments of the method, the third brine is delivered to the tank through one or more inlet ports for the third brine. The fourth brine may be removed from the tank using one or more outlet ports for the fourth brine. The one or more inlet ports for the first brine may be positioned lower in the tank than the one or more outlet ports for the fourth brine. The one or more outlet ports for the second brine may be positioned lower in the tank than the one or more inlet ports for the third brine.

In some embodiments of the method, the one or more inlet ports for the third brine are positioned higher in the tank than the one or more inlet ports for the first brine. In some embodiments, the one or more inlet ports for the third brine are positioned lower in the tank than the one or more outlet ports for the fourth brine. In some embodiments, the one or more inlet ports for the third brine are positioned higher in the tank than the one or more outlet ports for the fourth brine. In some embodiments, the one or more inlet ports for the third brine are positioned at least level with or lower in the tank than the one or more inlet ports for the first brine. In some embodiments, the one or more inlet ports for the third brine are positioned level in the tank with the one or more outlet ports for the fourth brine. In some embodiments, at least the one or more inlet ports for the first brine, the one or more outlet ports for the second brine, the one or more inlet ports for the third brine, or the one or more outlet ports for the fourth brine include one or more variable ports.

Some embodiments of the method include removing a fifth brine from the tank. A temperature of the fifth brine may be lower than the temperature of the third brine and a concentration of the fifth brine may be lower than the concentration of the third brine. The temperature of the fifth brine may be different from the temperature of the fourth brine or the concentration of the fifth brine may be different from the concentration of the fourth brine.

Some embodiments of the method further include delivering the fourth brine to a separator that forms the first brine from the fourth brine. Some embodiments include passing the fourth brine through a recuperator prior to delivering the fourth brine to the separator where the recuperator increases a temperature of the fourth brine through exchanging heat with the first brine delivered from the separator.

Some embodiments include a device that includes a tank with multiple inlet ports and multiple outlet ports. The multiple inlet ports may include one or more inlet ports positioned to deliver a first brine to the tank. The tank may be configured to melt at least a portion of one or more solids in the tank using the first brine in the tank to form a second brine. The multiple outlet ports may include one or more outlet ports positioned to remove the second brine from the tank such that a concentration of the second brine may be lower than a concentration of the first brine and a temperature of the second brine may be lower than a temperature of the first brine. The multiple inlet ports may include one or more inlet ports positioned to deliver a third brine to the tank where the third brine may be formed from the second brine after the second brine is utilized with respect to one or more loads and at least a temperature of the third brine may be higher than the temperature of the second brine or a concentration of the third brine may be lower than the concentration of the second brine. The tank may further be configured to melt at least an additional portion of the one or more solids using the third brine in the tank to form a fourth brine. The multiple outlet ports may include one or more outlet ports positioned to remove the fourth brine from the tank where a temperature of the fourth brine may be lower than the temperature of the third brine and a concentration of the fourth brine may be lower than the concentration of the third brine.

In some embodiments of the device, the one or more inlet ports positioned to deliver the first brine are positioned higher in the tank than the one or more outlet ports positioned to remove the second brine. In some embodiments, the one or more inlet ports positioned to deliver the first brine are positioned lower in the tank than the one or more outlet ports positioned to remove the fourth brine. In some embodiments, the one or more outlet ports positioned to remove the second brine are positioned lower in the tank than the one or more inlet ports positioned to deliver the third brine.

In some embodiments of the device, the one or more inlet ports positioned to deliver the third brine are positioned higher in the tank than the one or more inlet ports positioned to deliver the first brine. In some embodiments, the one or more inlet ports positioned to deliver the third brine are positioned lower in the tank than the one or more outlet ports positioned to remove the fourth brine. In some embodiments, the one or more inlet ports positioned to deliver the third brine are positioned higher in the tank than the one or more outlet ports positioned to remove the fourth brine. In some embodiments, the one or more inlet ports positioned to deliver the third brine are positioned at least level with or lower in the tank than the one or more inlet ports positioned to deliver the first brine. In some embodiments, the one or more inlet ports positioned to deliver the third brine are positioned level in the tank with the one or more outlet ports positioned to remove the fourth brine. In some embodiments, at least the one or more inlet ports positioned to deliver the first brine, the one or more outlet ports positioned to remove the second brine, the one or more inlet ports positioned to deliver the third brine, or the one or more outlet ports positioned to remove the fourth brine include one or more variable ports.

In some embodiments of the device, the multiple outlet ports include one or more outlet ports positioned to remove a fifth brine from the tank. A temperature of the fifth brine may be lower than the temperature of the third brine and a concentration of the fifth brine may be lower than the concentration of the third brine. At least the temperature of the fifth brine may be different from the temperature of the fourth brine or the concentration of the fifth brine may be different from the concentration of the fourth brine.

Some embodiments of the device further include a separator positioned to receive the fourth brine and form the first brine from the fourth brine. A recuperator may be positioned between the tank and the separator such that the fourth brine may pass through the recuperator prior to being delivered to the separator. The recuperator may increase a temperature of the fourth brine through exchanging heat with the first brine that may be delivered from the separator.

Some embodiments include a system that includes a solid maker that produces one or more solids that are delivered to a tank. The tank may include multiple inlet ports and multiple outlet ports. The multiple inlet ports may include one or more inlet ports positioned to deliver a first brine to the tank. The tank may be configured to melt at least a portion of one or more solids in the tank using the first brine in the tank to form a second brine. The multiple outlet ports may include one or more outlet ports positioned to remove the second brine from the tank where a concentration of the second brine may be lower than a concentration of the first brine and a temperature of the second brine may be lower than a temperature of the first brine. The multiple inlet ports may include one or more inlet ports positioned to deliver a third brine to the tank where the third brine is formed from the second brine after the second brine may be utilized with respect to one or more loads and at least a temperature of the third brine may be higher than the temperature of the second brine or a concentration of the third brine may be lower than the concentration of the second brine. The tank may further be configured to melt at least an additional portion of the one or more solids in the tank using the third brine in the tank to form a fourth brine. The multiple outlet ports may include one or more outlet ports configured to remove the fourth brine from the tank where a temperature of the fourth brine may be lower than the temperature of the third brine and a concentration of the fourth brine may be lower than the concentration of the third brine. A separator may be positioned to receive the fourth brine from the tank and form the first brine from the fourth brine. In some embodiments, the one or more inlet ports positioned to deliver the first brine may be positioned higher in the tank than the one or more outlet ports positioned to remove the second brine.

In some embodiments of the system, the one or more inlet ports positioned to deliver the first brine are positioned lower in the tank than the one or more outlet ports positioned to remove the fourth brine. The one or more outlet ports positioned to remove the second brine may be positioned lower in the tank than the one or more inlet ports positioned to deliver the third brine.

In some embodiments of the system, the one or more inlet ports positioned to deliver the third brine are positioned higher in the tank than the one or more inlet ports positioned to deliver the first brine. In some embodiments, the one or more inlet ports positioned to deliver the third brine are positioned lower in the tank than the one or more outlet ports positioned to remove the fourth brine. In some embodiments, the one or more inlet ports positioned to deliver third brine are positioned higher in the tank than the one or more outlet ports positioned to remove the fourth brine. In some embodiments, the one or more inlet ports positioned to deliver the third brine are positioned at least level with or lower in the tank than the one or more inlet ports positioned to deliver the first brine.

In some embodiments of the system, the one or more inlet ports positioned to deliver the third brine are positioned level in the tank with the one or more outlet ports positioned to remove the fourth brine. In some embodiments, the one or more inlet ports positioned to deliver the first brine, the one or more outlet ports positioned to remove the second brine, the one or more inlet ports positioned to deliver the third brine, or the one or more outlet ports positioned to remove the fourth brine include one or more variable ports.

In some embodiments of the system, the multiple outlet ports include one or more outlet ports positioned to remove a fifth brine from the tank; a temperature of the fifth brine may be lower than the temperature of the third brine and a concentration of the fifth brine may be lower than the concentration of the third brine. At least the temperature of the fifth brine may be different from the temperature of the fourth brine or the concentration of the fifth brine may be different from the concentration of the fourth brine.

Some embodiments of the system include the one or more loads. Some embodiments further include a recuperator positioned between the tank and the separator such that the fourth brine may pass through the recuperator prior to being delivered to the separator and the recuperator may increase a temperature of the fourth brine through exchanging heat with the first brine that may be delivered from the separator.

Some embodiments include methods, systems, and/or devices as described in the specification and/or shown in the figures.

The foregoing has outlined rather broadly the features and technical advantages of embodiments according to the disclosure in order that the detailed description that follows may be better understood. Additional features and advantages will be described hereinafter. The conception and specific embodiments disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A shows a device in accordance with various embodiments.

FIG. 1B shows a system and/or device in accordance with various embodiments.

FIG. 2 shows a system and/or device in accordance with various embodiments.

FIG. 3 show a system and/or device in accordance with various embodiments.

FIG. 4 shows a system and/or device in accordance with various embodiments.

FIG. 5 shows a system and/or device in accordance with various embodiments.

FIG. 6 shows a system and/or device in accordance with various embodiments.

FIG. 7 shows a system and/or device in accordance with various embodiments.

FIG. 8 shows system and/or device in accordance with various embodiments.

FIG. 9A shows a flow diagram of a method in accordance with various embodiments.

FIG. 9B shows a flow diagram of a method in accordance with various embodiments.

### DETAILED DESCRIPTION

This description provides embodiments, and is not intended to limit the scope, applicability, or configuration of the disclosure. Rather, the ensuing description will provide those skilled in the art with an enabling description for implementing embodiments of the disclosure. Various changes may be made in the function and arrangement of elements.

Thus, various embodiments may omit, substitute, or add various procedures or components as appropriate. For instance, it should be appreciated that the methods may be performed in an order different than that described, and that various stages may be added, omitted, or combined. Also, aspects and elements described with respect to certain embodiments may be combined in various other embodiments. It should also be appreciated that the following systems, devices, and methods may individually or collectively be components of a larger system, wherein other procedures may take precedence over or otherwise modify their application.

Multi-zone tank devices, systems, and methods for freeze point suppression cycles are provided in accordance with various embodiments. The multi-zone tanks may provide a direct contact recuperator between a freeze point suppression cycle's warm solid, such as ice, and cold dilute brine that may be integrated directly into the multi-zone tank; this integration may be used to solve various challenges such as subcooling the solid that may maximize ice efficiency and reducing the concentration of brine that may maximize cycle efficiency. Multi-zone tanks in accordance with various embodiments include two or more zones. Some embodiments include a bottom zone and a top zone, though other embodiments may include additional zones. The various zones are discussed in more detail below.

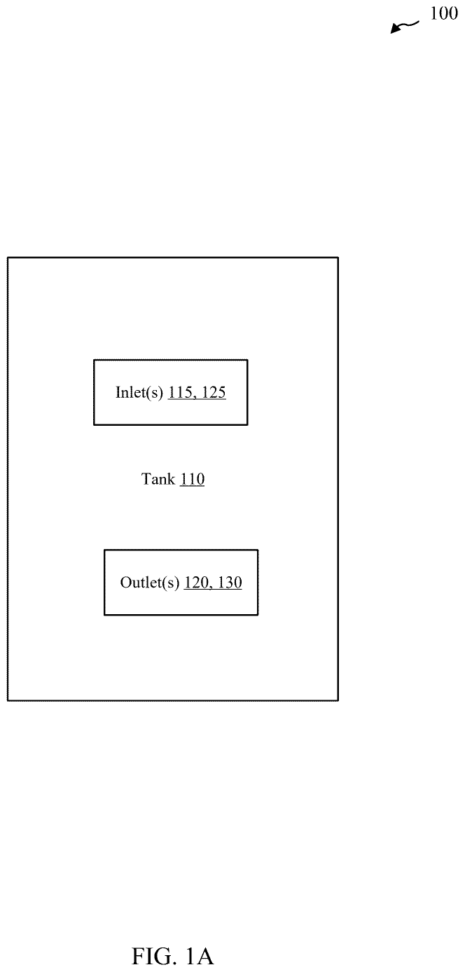

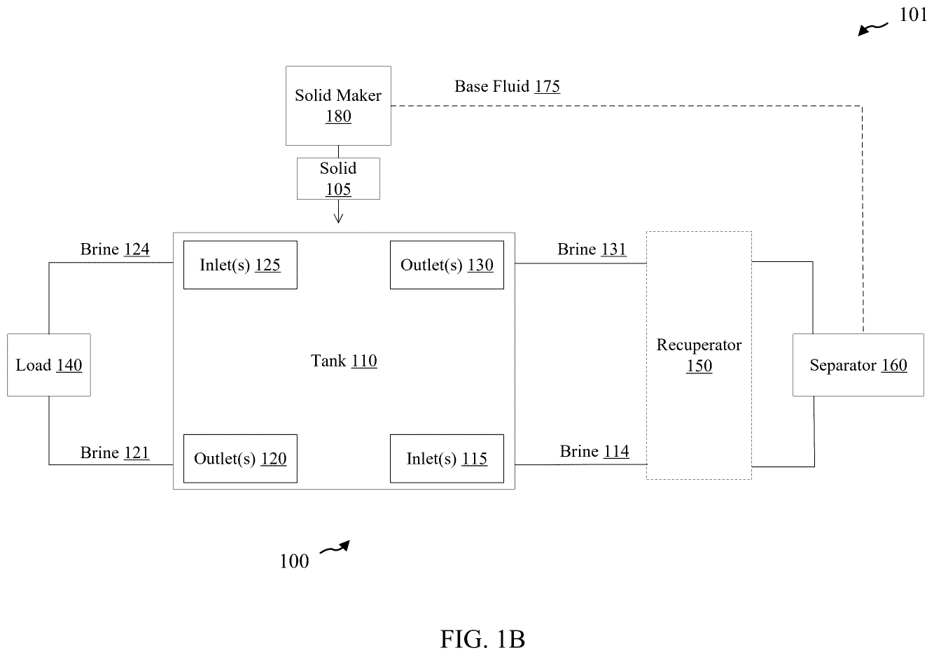

FIG. 1A shows a device 100 in accordance with various embodiments. Device 100 may be referred to as a multi-zone tank device. Device 100 includes a tank 110 that may include multiple inlet ports 115, 125 and multiple outlet ports 120, 130. These inlet ports 115, 125 and outlet ports 120, 130 may be positioned in order to create the multi-zone effect. Brines of various concentrations and/or temperatures may be introduced into multi-zone tank device 100 through inlet port(s) 115 and/or 125 and brines of various concentrations and/or temperatures may be removed through outlet port(s) 120 and/or 130. Ice or phase-changed solids in general are introduced through the top of the multi-zone tank 100 to combine with various brines coming from inlet port(s) 115 and/or 125. The inlet port(s) 115 and/or 125 along with outlet port(s) 120 and/or 130 may be configured such that their positioning with respect to multi-zone tank 100 may be changed. This may depend on a variety of factors such as the location of solid, such as ice, within multi-zone tank 100 or the desired temperatures and/or concentrations of brine desired to be removed from multi-zone tank 100 with respect to outlet port(s) 120 and/or outlet port(s) 130. A multi-zone effect within multi-zone tank 100 may generally be achieved through keeping inlet port(s) 125 and outlet port(s) 130 positioned higher than inlet port(s) 115 and outlet port(s) 120. Typically, inlet port(s) 115 may be positioned higher than outlet port(s) 120. In some embodiments, inlet port(s) 125 may be positioned lower than outlet port(s) 130; in some embodiments, this positioning may be flipped such that inlet port(s) 125 may be positioned higher than outlet port(s) 130. Multi-zone tank device 100 may also be referred to as a multi-zone ice tank and/or thermohalocline ice tank. Multi-zone tank device 100 may also be referred to as a two-zone ice tank or a two-zone tank in some embodiments. Most generally, multi-zone tank 100 may be referred to as a tank.

Merely by way of example, the device 100 may include a tank 110 with multiple inlet ports 115, 125 and multiple outlet ports 120, 130. The multiple inlet ports 115, 125 may include one or more inlet ports 115 positioned to deliver a first brine to the tank 110. The tank 110 may be configured to melt at least a portion of one or more solids in the tank 110 using the first brine in the tank 110 to form a second brine. The multiple outlet ports 120, 130 may include one or more outlet ports 120 positioned to remove the second brine from the tank 110 such that a concentration of the second brine may be lower than a concentration of the first brine and a temperature of the second brine may be lower than a temperature of the first brine. The multiple inlet ports 115, 125 may include one or more inlet ports 125 positioned to deliver a third brine to the tank 110 where the third brine may be formed from the second brine after the second brine is utilized with respect to one or more loads and at least a temperature of the third brine may be higher than the temperature of the second brine or a concentration of the third brine may be lower than the concentration of the second brine. The tank 110 may further be configured to melt at least an additional portion of the one or more solids using the third brine in the tank 110 to form a fourth brine. The multiple outlet ports 120, 130 may include one or more outlet ports 130 positioned to remove the fourth brine from the tank 110 where a temperature of the fourth brine may be lower than the temperature of the third brine and a concentration of the fourth brine may be lower than the concentration of the third brine.

In some embodiments of the device 100, the one or more inlet ports 115 positioned to deliver the first brine are positioned higher in the tank 110 than the one or more outlet ports 120 positioned to remove the second brine. In some embodiments, the one or more inlet ports 115 positioned to deliver the first brine are positioned lower in the tank 110 than the one or more outlet ports 130 positioned to remove the fourth brine. In some embodiments, the one or more outlet ports 120 positioned to remove the second brine are positioned lower in the tank 110 than the one or more inlet ports 125 positioned to deliver the third brine.

In some embodiments of the device 100, the one or more inlet ports 125 positioned to deliver the third brine are positioned higher in the tank 110 than the one or more inlet ports 115 positioned to deliver the first brine. In some embodiments, the one or more inlet ports 125 positioned to deliver the third brine are positioned lower in the tank 110 than the one or more outlet ports 130 positioned to remove the fourth brine. In some embodiments, the one or more inlet ports 125 positioned to deliver the third brine are positioned higher in the tank 110 than the one or more outlet ports 130 positioned to remove the fourth brine. In some embodiments, the one or more inlet ports 125 positioned to deliver the third brine are positioned at least level with or lower in the tank 110 than the one or more inlet ports 115 positioned to deliver the first brine. In some embodiments, the one or more inlet ports 125 positioned to deliver the third brine are positioned level in the tank 110 with the one or more outlet ports 130 positioned to remove the fourth brine. In some embodiments, at least the one or more inlet ports 115 positioned to deliver the first brine, the one or more outlet ports 120 positioned to remove the second brine, the one or more inlet ports 125 positioned to deliver the third brine, or the one or more outlet ports 130 positioned to remove the fourth brine include one or more variable ports.

In some embodiments of the device 100, the multiple outlet ports 120, 130 include one or more outlet ports 130 positioned to remove a fifth brine from the tank. A temperature of the fifth brine may be lower than the temperature of the third brine and a concentration of the fifth brine may be lower than the concentration of the third brine. At least the temperature of the fifth brine may be different from the temperature of the fourth brine or the concentration of the fifth brine may be different from the concentration of the fourth brine.

Some embodiments of the device 100 further include a separator positioned to receive the fourth brine and form the first brine from the fourth brine. A recuperator may be positioned between the tank 110 and the separator such that the fourth brine may pass through the recuperator prior to being delivered to the separator. The recuperator may increase a temperature of the fourth brine through exchanging heat with the first brine that may be delivered from the separator.

FIG. 1B shows system 101 in accordance with various embodiments. System 101 may include device 100 of FIG. 1A. System 101 may include a solid maker 180 that produces one or more solids 105 that may be delivered to the device 100. The device 100 may include a tank 110 that may include multiple inlet ports 115, 125 and multiple outlet ports 120, 130. The multiple inlet ports 115, 125 may include one or more inlet ports 115 positioned to deliver a first brine 114 to the tank 110. The tank 110 may be configured to melt at least a portion of one or more solids 105 in the tank 110 using the first brine 114 in the tank 110 to form a second brine 121. The multiple outlet ports 120, 130 may include one or more outlet ports 120 positioned to remove the second brine 121 from the tank 110 where a concentration of the second brine 121 may be lower than a concentration of the first brine 114 and a temperature of the second brine 121 may be lower than a temperature of the first brine 114. The multiple inlet ports 115, 125 may include one or more inlet ports 125 positioned to deliver a third brine 124 to the tank 110 where the third brine 124 may be formed from the second brine 121 after the second brine 121 may be utilized with respect to one or more loads 140 and at least a temperature of the third brine 124 may be higher than the temperature of the second brine 121 or a concentration of the third brine 124 may be lower than the concentration of the second brine 121. The tank 110 may further be configured to melt at least an additional portion of the one or more solids 105 in the tank 110 using the third brine 124 in the tank 110 to form a fourth brine 131. The multiple outlet ports 120, 130 may include one or more outlet ports 130 configured to remove the fourth brine 131 from the tank 110 where a temperature of the fourth brine 131 may be lower than the temperature of the third brine 124 and a concentration of the fourth brine 131 may be lower than the concentration of the third brine 124. A separator 160 may be positioned to receive the fourth brine 131 from the tank 110 and form the first brine 114 from the fourth brine 131. In some embodiments, the one or more inlet ports 115 positioned to deliver the first brine 114 may be positioned higher in the tank than the one or more outlet ports 120 positioned to remove the second brine 121.

In some embodiments of the system 101, the one or more inlet ports 115 positioned to deliver the first brine 114 are positioned lower in the tank than the one or more outlet ports 130 positioned to remove the fourth brine 131. The one or more outlet ports 120 positioned to remove the second brine 121 may be positioned lower in the tank 110 than the one or more inlet ports 125 positioned to deliver the third brine 124.

In some embodiments of the system 101, the one or more inlet ports 125 positioned to deliver the third brine 124 are positioned higher in the tank 110 than the one or more inlet ports 115 positioned to deliver the first brine 114. In some embodiments, the one or more inlet ports 125 positioned to deliver the third brine 124 are positioned lower in the tank 110 than the one or more outlet ports 130 positioned to remove the fourth brine 131. In some embodiments, the one or more inlet ports 125 positioned to deliver third brine 124 are positioned higher in the tank 110 than the one or more outlet ports 130 positioned to remove the fourth brine 131. In some embodiments, the one or more inlet ports 125 positioned to deliver the third brine 124 are positioned at least level with or lower in the tank 110 than the one or more inlet ports 115 positioned to deliver the first brine 114.

In some embodiments of the system 101, the one or more inlet ports 125 positioned to deliver the third brine 124 are positioned level in the tank 110 with the one or more outlet ports 130 positioned to remove the fourth brine 131. In some embodiments, the one or more inlet ports 115 positioned to deliver the first brine 114, the one or more outlet ports 120 positioned to remove the second brine 121, the one or more inlet ports 125 positioned to deliver the third brine 124, or the one or more outlet ports 130 positioned to remove the fourth brine 131 include one or more variable ports.

In some embodiments of the system 101, the multiple outlet ports 120, 130 include one or more outlet ports 130 positioned to remove a fifth brine from the tank; a temperature of the fifth brine may be lower than the temperature of the third brine 124 and a concentration of the fifth brine may be lower than the concentration of the third brine 124. At least the temperature of the fifth brine may be different from the temperature of the fourth brine 131 or the concentration of the fifth brine may be different from the concentration of the fourth brine 131.

Some embodiments of the system 101 include the one or more loads 140. Some embodiments further include a recuperator 150 positioned between the tank 110 and the separator 160 such that the fourth brine 131 may pass through the recuperator 150 prior to being delivered to the separator 160 and the recuperator 150 may increase a temperature of the fourth brine 131 through exchanging heat with the first brine 114 that may be delivered from the separator 160. In some embodiments, the separator 160 may form a base fluid 175 from the fourth brine 131; the base fluid 175 may be delivered to the solid maker 180 to form the one or more solids 105.

In general, the one or more solids 105 may be formed from solidifying a base fluid 175, which also may be referred to as a refrigerant. Solidifying the base fluid 175 may generally be referred to as freezing the base fluid. Water is one example of a base fluid 175, though other base fluids 175 may be utilized, including, but not limited to an organic material, an ionic liquid, an inorganic material, a non-ionic liquid, a mixture of materials, and/or a pure material. The use of the term brine then generally refers to a base fluid 175 being combined or mixed with an additive that is soluble in the base fluid 175. The additive may be referred to as a freeze point suppressant. Salt is one example of an additive, though other additives may be utilized, including, but not limited to water, alcohol, ionic liquids, amines, ammonia, non-salt soluble solids, organic substances, inorganic substances, mixtures of miscible materials, and/or a surfactant-stabilized mixture of immiscible materials.

Utilizing the brine 121 with respect to one or more loads 140 generally involves utilizing the brine 121 through a thermal couple to various devices and/or systems, including, but not limited to, a refrigeration device, a freezer device, an HVAC device, an evaporator, an air-cooler, a cooling jacket, a coolant loop, an air handler, a cooling coil, an immersion cooler, a bath cooler, an electrical generator (e.g., heat-engine based electrical generator, a fuel-cell based electrical generator, and/or a photovoltaic-based electrical generator), and/or a heat engine. The thermal couple may include, but is not limited to, a direct heat exchanger and/or an indirect heat exchanger or a combination of multiple different styles of heat exchangers.

Separator 160 may include a mechanical vapor recompression distillation process, for example. This process may use a directly integrated heat engine to make the steam's own heat of vaporization available to do useful work on the brine. Other concentration or separation techniques may be utilized, including, but not limited to reverse osmosis, nano-filtration, photonic driven precipitation, precipitation by chemical reaction, precipitation by solubility change, surfactant absorption, ion exchange, activated carbon absorption, flash separation, distillation, multi-effect distillation, vapor compression distillation, evaporation, membrane distillation, electrodialysis, gas permeable membrane separation, and/or membrane separation in general.

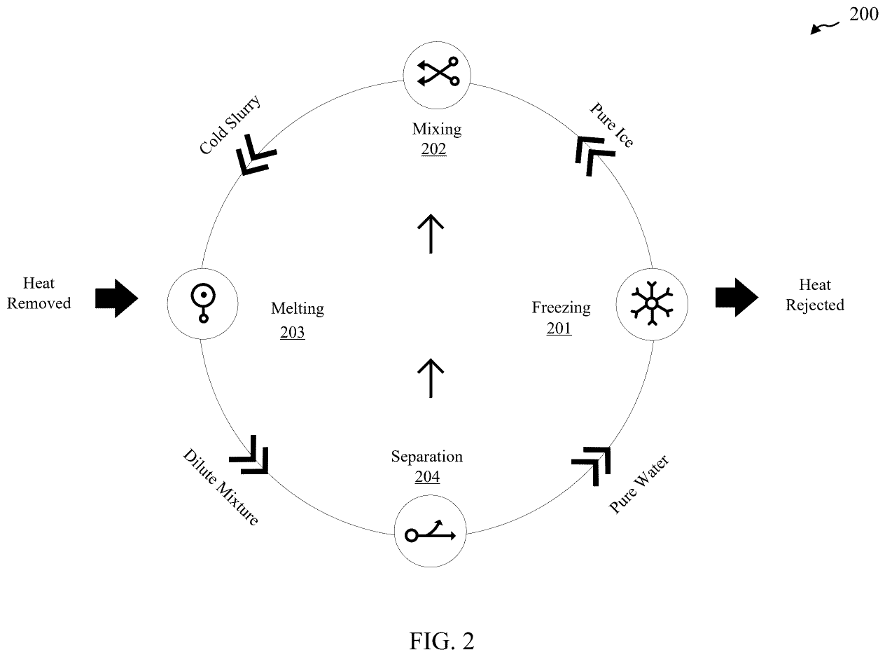

To facilitate a better understanding of the use of a multi-zone tank, such as device 100 of FIG. 1A and/or FIG. 1B, one may consider FIG. 2, which shows an example of a freeze point suppression cycle 200, which may also be referred to as a freeze point suppression system. Typically, freeze point suppression cycle 200 moves a refrigerant, which may be referred to as a base fluid, through different processes and states to move heat from a low temperature to a high temperature. Where a vapor compression cycle typically uses evaporation and condensation at different pressures, the freeze point suppression cycle may use melting and freezing at different chemical compositions. In both cases, a heat pump effect may be produced; heat may be removed from a cold environment and may be pumped to a higher temperature environment. For the freeze point suppression cycle 200, this may be done in four steps as generally shown in FIG. 2. Some embodiments include a freezing step 201, where a refrigerant, which may be pure, is generally frozen; this may dump heat out of the cycle to ambient. Water is one example of a refrigerant, though other refrigerants may be utilized, including, but not limited to an organic material, an ionic liquid, an inorganic material, a non-ionic liquid, a mixture of materials, and/or a pure material. More generally, step 201 may involve forming a solid from a base fluid.

A mixing step 202 may include the frozen refrigerant that may be mixed with a freeze point suppressant. Salt is one example of a freeze point suppressant, though other freeze point suppressants may be utilized, including, but not limited to water, alcohol, ionic liquids, amines, ammonia, non-salt soluble solids, organic substances, inorganic substances, mixtures of miscible materials, and/or a surfactant-stabilized mixture of immiscible materials. The mixture may spontaneously cool as the suppressant melts a portion of the frozen refrigerant (such as ice). A cooling or melting step 203 may include absorbing or removing heat at a low temperature by melting the frozen refrigerant, such as melting ice. The multi-zone tank device 100 of FIG. 1A and/or FIG. 1B may be the site of the mixing steps 202 and melting steps 203 of the freeze point suppression cycle 200. The multi-zone tank device 100 of FIG. 1A and/or FIG. 1B may store the energy between the electricity consumption steps and cooling consumption steps.

Freeze point suppression cycles may also include a separation step 204 that may include separating the refrigerant and the freeze point suppressant. This may create the refrigerant, which may be pure refrigerant, and a concentrated freeze point suppressant.

This process may be made continuous by constantly forming one or more solids (e.g., ice), feeding the one or more solids into a tank (such as multi-zone tank 100 of FIG. 1A and/or FIG. 1B), and mixing that solid (e.g., ice) with brine. The tank's concentration may be in a dynamic steady state. It may be continuously diluted by the melting of the solid (e.g., ice) caused by the heat gained by providing refrigeration. At the same time, the tank's concentration may be raised by the continuous removal of dilute brine and supply of concentrated brine.

The concentration or separation step 204 may be performed by a mechanical vapor recompression distillation process, for example. This process may use a directly integrated heat engine to make the steam's own heat of vaporization available to do useful work on the brine. Other concentration or separation techniques may be utilized, including, but not limited to reverse osmosis, nano-filtration, photonic driven precipitation, precipitation by chemical reaction, precipitation by solubility change, surfactant absorption, ion exchange, activated carbon absorption, flash separation, distillation, multi-effect distillation, vapor compression distillation, evaporation, membrane distillation, electrodialysis, gas permeable membrane separation, and/or membrane separation in general.

In some embodiments, freeze point suppression cycles, such as cycle 200, use non-toxic, non-flammable, and non-corrosive potassium acetate brine. They may include various subsystems including, but not limited to, the following components. For example, some embodiments include an ice maker (or solid maker more generally). The ice maker for freeze point suppression systems may produce completely dry subcooled ice at a low energy density and a high rate per surface area. Some embodiments utilize a surface-chemistry based ice maker that may use standard ice making thermal equipment but harvests ice via a subcooling step instead of a defrost step. This ice maker may be agnostic to refrigerant and may be run using zero global warming potential refrigerants like ammonia. Some embodiments include a tank (such as multi-zone tank device 100 of FIG. 1A and/or FIG. 1B). The tank may be built from a variety of materials such as fiberglass or plastic, though other materials may be utilized, where the ice and brine interact; other materials may be utilized. Some embodiments include a wet scrubber, such as a desiccant-style web scrubber, that may provide a large surface area between brine and air to allow for both heat and mass transfer. Some embodiments include one or more thermal recuperators. These thermal recuperators may include a series of heat exchangers that take the heat in the water and concentrated brine leaving the separation system and exchange it into the dilute brine leaving the tank. In this way, the dilute brine may be pre-heated and the concentrated brine may be pre-cooled. Some embodiments include one or more concentrators or separators that utilize a variety of techniques including, but not limited to, mechanical vapor recompression distillation, reverse osmosis, nano-filtration, photonic driven precipitation, precipitation by chemical reaction, precipitation by solubility change, surfactant absorption, ion exchange, activated carbon absorption, flash separation, distillation, multi-effect distillation, vapor compression distillation, evaporation, membrane distillation, electrodialysis, gas permeable membrane separation, and/or membrane separation in general. Some separation techniques may utilize one or more compressors; some embodiments utilize a high-speed centrifugal steam compressor. Merely by way of example, some embodiments can achieve a compression ratio (CR) of 1.5 to 1.8. This compression enables the boiler to have brine on one side at 14.5 psig boiling at 234 °F and steam on the other side condensing at 22 psig and 240 °F.

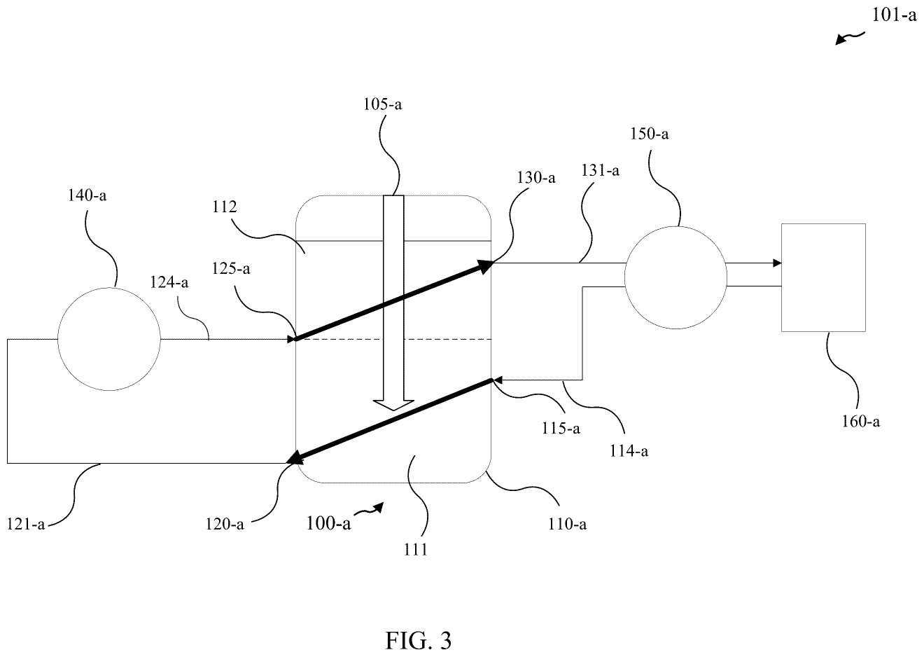

Turning now to FIG. 3, aspects of a system 101-a in accordance with various embodiments are shown; system 101-a may provide an example of a freeze point suppression system or cycle that includes a multi-zone tank device 100-a. Device 100-a may include a multi-zone tank 100-a as provided in accordance with various embodiments. Aspects of system 101-a may be examples of aspects of freeze point suppression cycle 200 of FIG. 2 and multi-zone tank 100 of FIG. 1A and FIG. 1B; system 101-a may be an example of system 101 of FIG. 1B. Device 100-a may serve various functions in a freeze point suppression cycle, which may be used for energy storage and/or other purposes. The multi-zone tank device 100-a may be the site of the mixing and melting steps of the freeze point suppression cycle 200 as noted above. The multi-zone tank device 100-a may store the energy between the electricity consumption steps and cooling consumption steps. In general, multi-zone tank device 100-a may be referred to as an ice tank or a tank; in this example, the multi-zone tank device 100-a may be referred to as a two-zone ice tank device or a two-zone tank device. The two-zone tank device 100-a generally includes a tank 110-a along with inlet port(s) 115-a, outlet port(s) 120-a, inlet port(s) 125-a, and outlet port(s) 130-a.

The role of the multi-zone tank device 100-a in the freeze point suppression cycle may include mixing a solid, such as the solid refrigerant (ice, for example) with the freeze point suppressant (concentrated brine, for example) and may melt the refrigerant at the resulting low temperature to make the cooling usefully available (cold dilute brine, for example). In doing so, it may convert chemical potential in the form of a concentration differential into a decrease in temperature.

The efficiency of this process may be referred to as solid or ice efficiency and may be defined as the ratio of the cooling power available as latent heat melts the solid, such as ice, at the load temperature to the cooling power that may be involved to solidify the solid, such as freeze the ice, at its normal freezing point.

Some embodiments utilize a direct contact recuperator between the warm solid such as ice and the cold dilute brine integrated directly into the multi-zone tank device 100-a that may be used to solve both the challenges of subcooling the solid, such as ice, that may maximize solid or ice efficiency and reducing the concentration of brine that may maximize cycle efficiency. Some embodiments achieve this utilizing the multi-zone tank device 100-a of FIG. 3. Some multi-zone tank devices 100-a may include a bottom zone 111 and a top zone 112, for example.

The bottom zone 111 of the two-zone tank device 100-a may do the freeze point suppression cycle's mixing step and most of the melting step (see steps 202 and 203 of FIG. 2, for example). The solid 105-a, such as ice, and concentrated brine, which may both be cooled to just above the saturated mixture temperature, may be supplied from the top of this zone. Flowing downward through the zone, they may mix and the solid, such as ice, melts; this may result in a dilute brine mixture at its saturation temperature. The cold dilute brine 121-a may be extracted from the bottom of the tank and pumped to the load heat exchanger 140-a.

The top zone 112 of the two-zone tank device 100-a may serve as a direct contact solid (e.g., ice) recuperator. The relatively warm dilute brine 124-a returning from the load heat exchanger 140-a may be injected into the bottom of this zone (the middle of the tank approximately) while solid 105-a, such as ice, may be supplied from the top of the tank 110-a. The brine, unintuitively, may cool back down to its new slightly higher saturation temperature by melting a small amount of the solid 105-a, such as ice. This may slightly dilute the brine, resulting in brine 130-a. The solid 105-a, which may be slowly flowing downward through the zone, may likewise be cooled to the saturation temperature of the mixture before entering to the bottom zone 111 of the two-zone tank device 100-a.

The two-zone tank device 100-a may have numerous benefits because each zone generally achieves a goal toward maximizing the cycle efficiency. The bottom zone 111 generally converts the maximum differential chemical potential (i.e., minimum dilution) into temperature reduction. It may do this by minimizing the sensible cooling load of the incoming stream, which may maximize the cycle efficiency. The top zone 112 may convert the maximum sensible heat capacity (i.e., a higher temperature brine 124-a returning from the load 140-a) into maximum dilution. Maximum dilution, in turn, may be easily converted into reduced power used in the separation step.

The two-zone tank device 100-a may also be highly appropriate for enabling the tank 110-a to serve other purposes, such as holding the solid 105-a, such as ice, and concentrated brine that store energy between power input and cooling output processes. One advantage may include that it may decouple the load 140-a from the separation process 160-a. With the tank 110-a generally full of relatively concentrated brine and solid (e.g., ice), the load 140-a, the separator 160-a, and a solid maker (not shown; see FIG. 1B for an example) may all run keeping it at steady state or the separator 160-a and solid maker (e.g., ice maker) may shut off while the load 140-a keeps running; reference number 105-a may also refer generally to ice and/or a phase-changed solid. In the latter case, the dilution step may no longer be involved to improve separation performance, so the entire tank 110-a effectively may be converted into the bottom zone 111 by moving the brine injection level up. The load 140-a may thereby continue to operate, which may eventually convert all the stored energy into load cooling. This contrasts with other architectures in which the load 140-a and the separator 160-a may run in series and the efficiency and operability may suffer when one runs without the other.

Another advantage may be that the two-zone tank device 100-a may be inherently highly scalable. The manifestation of the two-zone tank device 100-a may be simply a low-pressure tank with many available inlet and outlet ports. There may be no physical division between the zones so that it may be used to provide a cooling load at any ice level or separation status. The multi-zone tank device 100-a itself is generally easy to scale from the minimum size desired to achieve adequate mixing and melting up to very large volumes capable of storing many hours of energy between the power input process and the cooling output process.

System 101-a may also include a recuperator 150-a that may provide heat transfer between the diluted brine 131-a coming from the top zone 112 of two-zone tank device 100-a and concentrated brine 114-a returning to the bottom zone 111 of two-zone tank device 100-a. This may warm the brine that may be sent to the separation process 160-a while cooling the concentrated brine 114-a returning to bottom zone 111 of two-zone tank device 100-a. The use of recuperator 150-a may take the cooling capacity of the brine 131-a that is leaving the two-zone tank device 100-a and put it back into the concentrated brine 114-a that may be introduced into the lower or bottom(s) 111 of two-zone tank device 100-a, which may optimize its capacity going into the two-zone tank device 100-a.

In FIG. 3, the vertical arrow pointing down generally shows the flow of one or more solids 105-a (such as ice) while the diagonal arrows generally reflect brine flows. The use of multi-zone tank device 100-a may allow one to vary the various inputs, such as ice and brine, along with the brine input and output locations to vary various efficiencies, such as solid efficiency (e.g., ice efficiency), separation efficiency, and/or overall cycle efficiency.

Merely by way of example as shown in FIG. 3, a brine 114-a may enter multi-zone tank device 100-a through inlet port 115-a into a lower or bottom zone 111. The brine 114-a may have a first concentration and a first temperature; brine 114-a may be referred to as a highest concentration cold brine. The brine 114-a may combine and mix with the one or more solids 105-a and melt at least a portion of the one or more solids 105-a resulting in a brine 121-a that may leave the multi-zone tank device 100-a through outlet port 120-a. Outlet port 120-a, in general, may be positioned lower in the tank than inlet port 115-a. Brine 121-a may have a second concentration and a second temperature; brine 121-a may be referred to as a moderate concentration coldest brine. The second concentration of brine 121-a may be lower than the first concentration of brine 114-a and the second temperature of brine 121-a may be lower than the first temperature of brine 114-a.

In some embodiments, the brine 121-a from outlet port 120-a may be utilized with respect to load 140-a; the brine 121-a may provide cooling for the load 140-a, for example. A brine 124-a may then return to the multi-zone tank 100-a through inlet port 125-a. Brine 124-a may have a third concentration and a third temperature; brine 124-a may be referred to as moderate concentration warm brine. The third concentration of brine 124-a may be approximately the same as the second concentration of brine 121-a. The third concentration of brine 124-a may be lower than the second concentration of brine 121-a; for example, the third brine 124-a may be received from a load 140-a, such as a wet scrubber, that may absorb water resulting in the third brine 124-a having a lower concentration than brine 121-a. The third temperature of brine 124-a may be higher than the second temperature of brine 121-a.

Brine 124-a may mix and melt at least another portion of the one or more solids 105-a in the upper or top zone 112 of multi-zone tank device 100-a. A resulting brine 131-a may be removed from the multi-zone tank device 100-a through outlet port 130-a. Brine 131-a may have a fourth concentration and a fourth temperature; brine 131-a may be referred to as a minimum concentration cold brine. The fourth concentration of brine 131-a may be lower than the third concentration of brine 124-a, while the fourth temperature of brine 131-a may be lower than the third temperature of brine 124-a. Brine 131-a may be sent through recuperator 150-a, which may result in brine 131-a being warmed, while brine 114-a that is returning to multi-zone tank device 100-a may be cooled; brine 114-a may be concentrated brine from separation process 160-a.

In general, inlet port(s) 125-a may be positioned lower in the multi-zone tank device 100-a than outlet port(s) 130-a. However, in some embodiments, inlet port(s) 125-a may be positioned higher in the multi-zone tank device 100-a than outlet port(s) 130-a. Also, inlet port(s) 125-a may be positioned higher in the multi-zone tank 100-a than inlet port(s) 115-a; outlet port(s) 130-a may also be positioned, in general, higher in the multi-zone tank device 100-a than inlet port(s) 115-a. Through keeping these relationships, brine mixing between zones may be avoided, such as between the top zone 112 and the bottom zone 111.

In some embodiments of device 100-a, the inlet port(s) 125-a positioned to deliver the brine 124-a are positioned at least level with or lower in the tank 110-a than the inlet port(s) 115-a positioned to deliver the brine 114-a. In some embodiments, the inlet port(s) 125-a positioned to deliver the brine 124-a are positioned level in the tank 110-a with the outlet port(s) 130-a positioned to remove the brine 131-a.

In some embodiments, multiple zones may be created, such as from the upper or top zone 112, through including multiple outlet ports 130. This may allow for multiple brine streams 131-a to be removed from the multi-zone tank device 100-a to allow for brines with different temperatures and/or concentrations to be removed from multi-zone tank device 100-a.

Furthermore, inlet port(s) 115-a, inlet port(s) 125-a, outlet port(s) 120-a, and/or outlet port(s) 130-a may be configured such that their positions may be altered to impact where the respective brines may be introduced into the multi-zone tank device 100-a or removed from the multi-zone tank device 100-a. This may be achieved in a variety of ways, such as mechanically moving the inlet and/or outlet port(s) or through configuring multiple inlet and/or outlet ports for each of these respective areas and then selectively opening and closing the respective inlet and/or outlet port(s). In some embodiments, the various inlet and/or outlet ports are configured as pipes running down the side of the multi-zone tank device 100-a. Each pipe may include multiple apertures formed in a spiral around the pipe. The pipe may be rotated to align a respective opening in the pipe to either introduce or remove brine from the tank. The unaligned apertures may be blocked around the circumference utilizing an outer pipe in some cases. Altering where brine is delivered and/or removed from the multi-zone tank device 100-a may allow for various optimizations, such as controlling where brine is delivered or removed from multi-zone tank device 100-a such as to keep approximately equal amounts of solid (e.g., ice) in both the top zone 112 and the bottom zone 111.

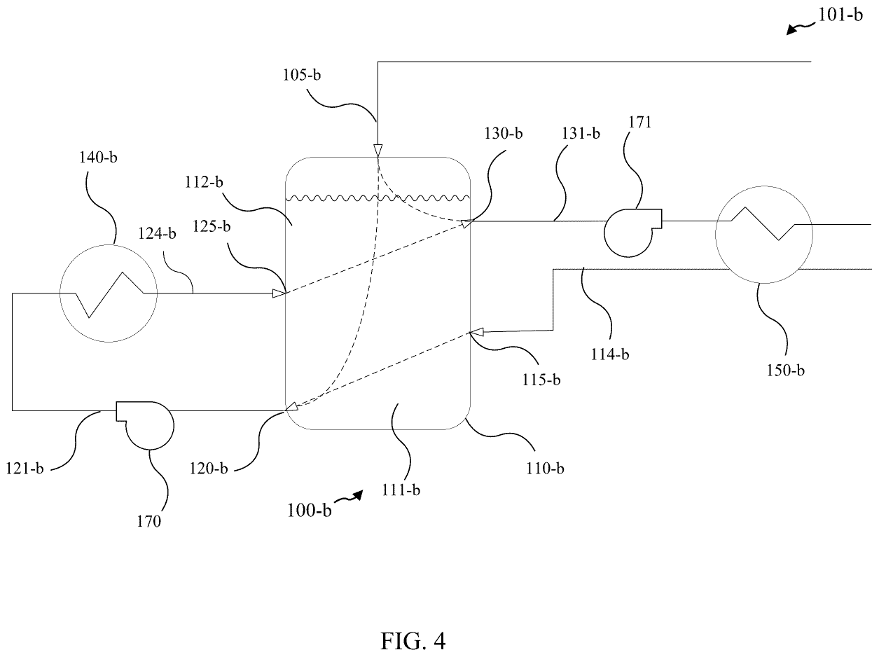

Thermodynamic statepoint modeling generally indicates that the two-zone tank devices in accordance with various embodiments may unlock higher efficiencies at lower temperatures with flexible storage. For example, FIG. 4 shows a system 101-b in accordance with various embodiments that may show one instance of a two-zone tank device 100-b where the bottom zone 111-b generally converts cold solid, such as ice, and concentrated brine to what may be a minimally-diluted and maximally-cold mixture for supply to a load 140-b. System 101-b may be an example of aspects of system 101 of FIG. 1B, system 200 of FIG. 2 and/or system 101-a of FIG. 3, while multi-zone tank device 100-b may be an example of multi-zone tank device 100 of FIG. 1A, FIG. 1B, and/or multi-zone tank device 100-a of FIG. 3. The top zone 112-b generally converts warmer solid 105-b, such as ice, and warmer partially-diluted brine to what may be a maximally diluted brine ready to supply to the separation process. In general, system 101-b shows similar structures as those shown in FIG. 3 including, but not limited to multi-zone tank device 100-b, lower/bottom zone 111-b, upper/top zone 112-b, inlet port 115-b, outlet port 120-b, inlet port 125-b, and outlet port 130-b. Brines with various temperatures and concentrations are also shown, including brines 114-b, 121-b, 124-b, and 131-b. A load 140-b, a recuperator 150-b, and a solid source or solid 105-b may also be shown; a separator, not shown, may take the brine from recuperator 150-b coming from brine 131-b and deliver a concentrated brine back to recuperator 150-b that forms brine 114-b. Some embodiments of system 101-b include a solid maker (not shown). Pumps 170, 171 may also be shown. The following temperatures and concentrations for the brines and/or solid, such as ice, are provided merely as examples; other configurations may result in other temperatures and/or concentrations. For example, one or more solids 105-b, such as ice, may be delivered to multi-zone tank device 100-b at 0.0 °C, 0.3773 kg/s. Brine 114-b may be delivered to multi-zone tank device 100-b at −23.0 °C, 0.37 wtCon. Brine 121-b may be removed from multi-zone tank device 100-b at −30.0 °C, 2.668 kg/s, 0.35 wtCon. Brine 124-b may be delivered to multi-zone tank device 100-b at −20.0 °C. Brine 131-b may be removed from multi-zone tank device 100-b at −25.0 °C, 2.864 kg/s, 0.32 wtCon.

In comparison, an actively-mixed single zone tank may waste available chemical potential and sensible heat recuperation potential. For example, ice at 0 °C may be mixed with 40% concentration brine to generate −30 °C brine at 34% concentration. The ice efficiency of that configuration may have only 66% (modelled and validated empirically), while involving a more difficult separation process due to higher concentrations. A two-zone tank with the same constraints may have an ice efficiency of 85%, while also decoupling the load from the separation process and reducing the separation power requirement. The embodiment shown in FIG. 4 may trade off some of that ice efficiency for lower load temperatures while still achieving an ice efficiency of 72%, for example. The numerical values provided in this example are provided merely as examples; other embodiments may result in different values.

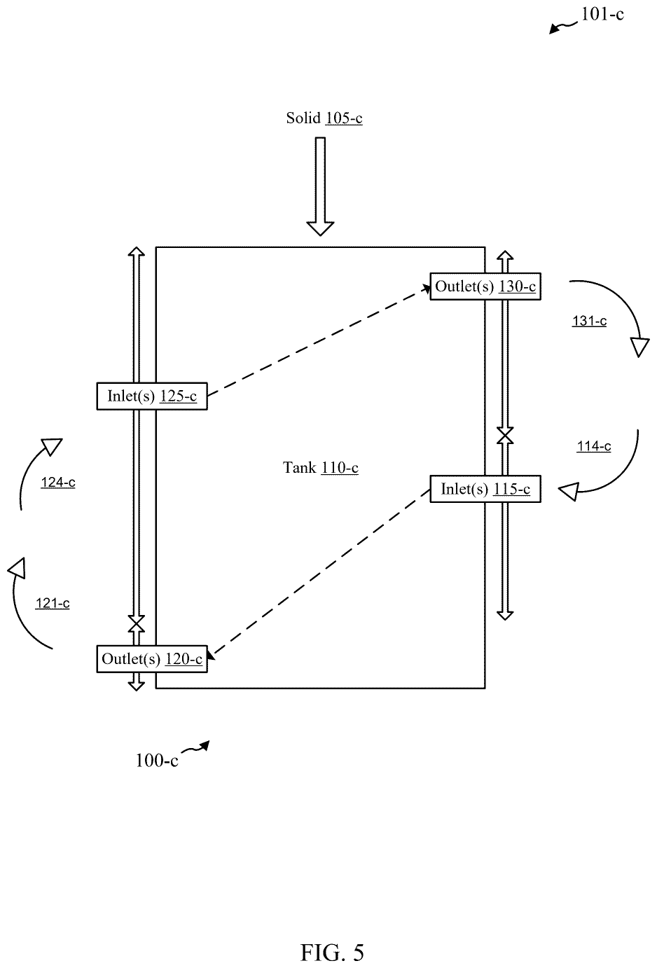

Turning now to FIG. 5, aspects of a system 101-c are provided in accordance with various embodiments. System 101-c may be an example of aspects of system 101 of FIG. 1B, system 200 of FIG. 2, system 101-a of FIG. 3 and/or system 101-b of FIG. 4, while multi-zone tank device 100-c may be example of tank device 100 of FIG. 1A, FIG. 1B, device 100-a of FIG. 3, and/or device 100-b of FIG. 4. Tank device 100-c may include a tank 110-c with inlet port(s) 115-c, outlet port(s) 120-c, inlet port(s) 125-c, and/or outlet port(s) 130-c. A brine 114-c may enter the multi-zone tank device 100-c through inlet port(s) 115-c. The brine 114-c may have a first concentration and a first temperature; brine 114-c may be referred to as a highest concentration cold brine. The brine 114-c may combine and mix with one or more solids 105-c, such as ice, and melt at least a portion of the one or more solids 105-c resulting in a brine 121-c that may leave the multi-zone tank device 100-c through outlet port(s) 120-c. Outlet port(s) 120-c in general are positioned lower in the tank than inlet port(s) 115-c. Brine 121-c may have a second concentration and a second temperature; brine 121-c may be referred to as a moderate concentration coldest brine. The second concentration of brine 121-c may be lower than the first concentration of brine 114-c and the second temperature of brine 121-c may be lower than the first temperature of brine 114-c.

In some embodiments, the brine 121-c from outlet port(s) 120-c may be utilized with respect to one or more loads (not shown); the brine 121-c may provide cooling for the load 140-c, for example. A brine 124-c may then return to the multi-zone tank device 100-c through inlet port(s) 125-c. Brine 124-c may have a third concentration and a third temperature; brine 124-c may be referred to as moderate concentration warm brine. The third concentration of brine 124-c may be approximately the same as the second concentration of brine 121-c. The third concentration of brine 124-c may be lower than the second concentration of brine 121-c; for example, the third brine 124-c may be received from a load, such as a wet scrubber, that may absorb water resulting in the third brine 124-c having a lower concentration than brine 121-c. The third temperature of brine 124-c may be higher than the second temperature of brine 121-c.

As suggested by the range and positioning of the arrows with respect to the inlet(s) 115-c, inlet(s) 125-c, outlet(s) 120-c, and/or outlet(s) 130-c, in some embodiments of device 100-c, the inlet port(s) 125-c positioned to deliver the brine 124-c are positioned at least level with or lower in the tank 110-c than the inlet port(s) 115-c positioned to deliver the brine 114-c. In some embodiments, the inlet port(s) 125-c positioned to deliver the brine 124-a are positioned level in the tank 110-a with the outlet port(s) 130-a positioned to remove the brine 131-a.

Brine 124-c may mix and melt at least an additional portion of the one or more solids 105-c in the multi-zone tank device 100-c. A resulting brine 131-c may be removed from the multi-zone tank device 100-c through outlet port(s) 130-c. Brine 131-c may have a fourth concentration and a fourth temperature; brine 131-c may be referred to as a minimum concentration cold brine. The fourth concentration of brine 131-c may be lower than the third concentration of brine 124-c, while the fourth temperature of brine 131-c may be lower than the third temperature of brine 124-c. Brine 131-c may be sent through a recuperator (not shown), which may result in brine 131-c being warmed, while brine 114-c that is returning to multi-zone tank 100-c may be cooled; brine 114-c may be concentrated brine from a separation process (not shown). Some embodiments of system 101-c include a solid maker (not shown).

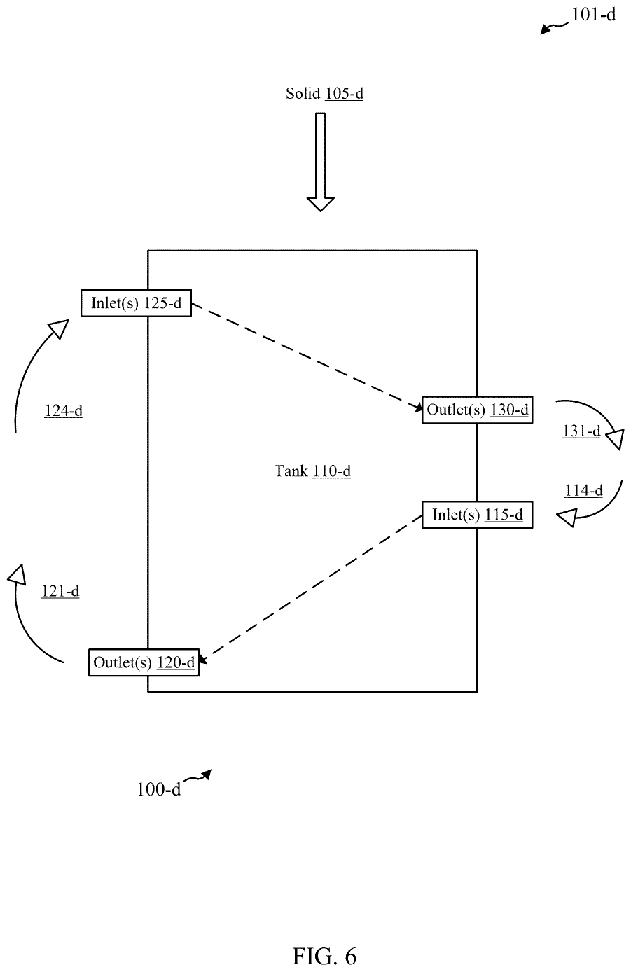

In general, inlet port(s) 125-c may be positioned lower in the multi-zone tank 100-c than outlet port(s) 130-c. However, in some embodiments, inlet port(s) 125-c may be positioned higher in the multi-zone tank 100 than outlet port(s) 130-c. FIG. 6 provides a system 101-d in accordance with various embodiments that may show such a configuration. Inlet port(s) 125-d and outlet port(s) 130-d may be positioned higher in the multi-zone tank 100-d than inlet port(s) 115-d and outlet port(s) 120-d with respect to tank 110-d. Through keeping these relationships, brine mixing between zones may be avoided. System 101-d also shows first brine 114-d, second brine 121-d, third brine 124-d, and fourth brine 131-d. One or more loads may be positioned with respect to second brine 121-d and third brine 124-d, though not shown here. A separator (not shown) may be positioned with respect to fourth brine 131-d and first brine 114-d. A solid 105-d delivered to tank 110-d is also shown; some embodiments of system 101-d include a solid maker (not shown).

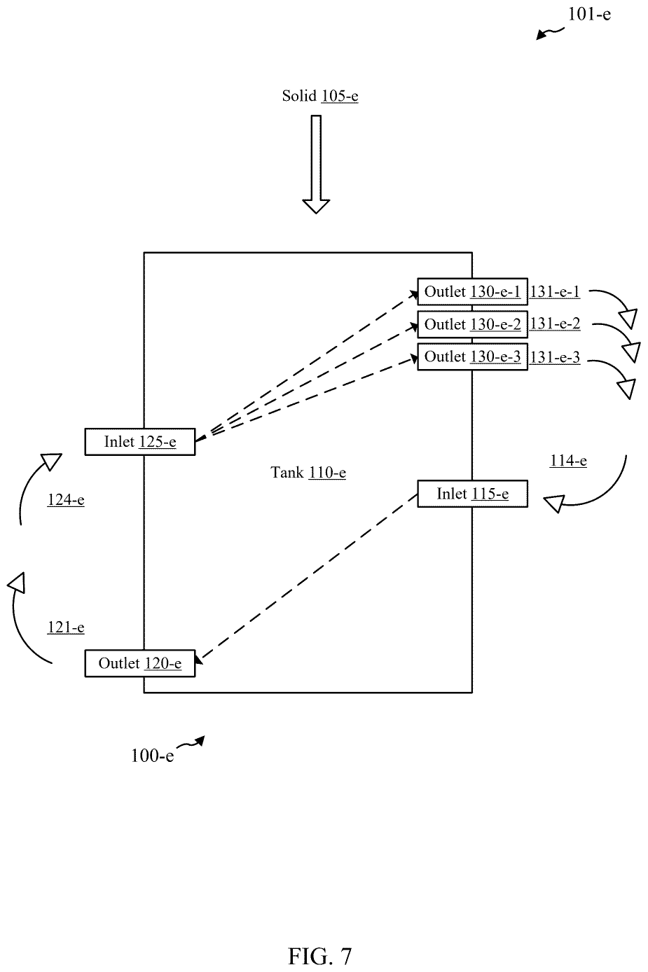

In some embodiments, multiple zones may be created, such as from the upper or top zone(s) through including multiple outlet ports 130. This may allow for multiple brine streams 131 to be removed from multi-zone tank 110 to allow for brines with different temperatures and/or concentrations to be removed from the multi-zone tank 100. FIG. 7 provides a system 101-e in accordance with various embodiments that may show such a configuration, with multiple outlet ports 130-e shown. In this example, multiple outlet ports 130-e-1, 130-e-2, and 130-e-3 may be utilized, though some embodiments may include more or fewer outlet ports with multiple brines 131-e-1, 131-e-2, and 131-e-3 being removed from the multi-zone tank device 100-e. Some embodiments may include more or fewer brine streams 131-e. Multi-zone tank device 100-e may also include tank 110-e along with inlet port(s) 115-e, outlet port(s) 120-e, and inlet port(s) 125-e. System 101-e also shows first brine 114-e, second brine 121-e, and third brine 124-e. One or more loads (not shown) may be positioned with respect to second brine 121-e and third brine 124-e, though not shown here. A separator and/or recuperator (not shown) may be positioned with respect to fourth brines 131-e and first brine 114-e, though not shown here. A solid 105-e delivered to tank 110-e is also shown. Some embodiments of system 101-e include a solid maker (not shown).

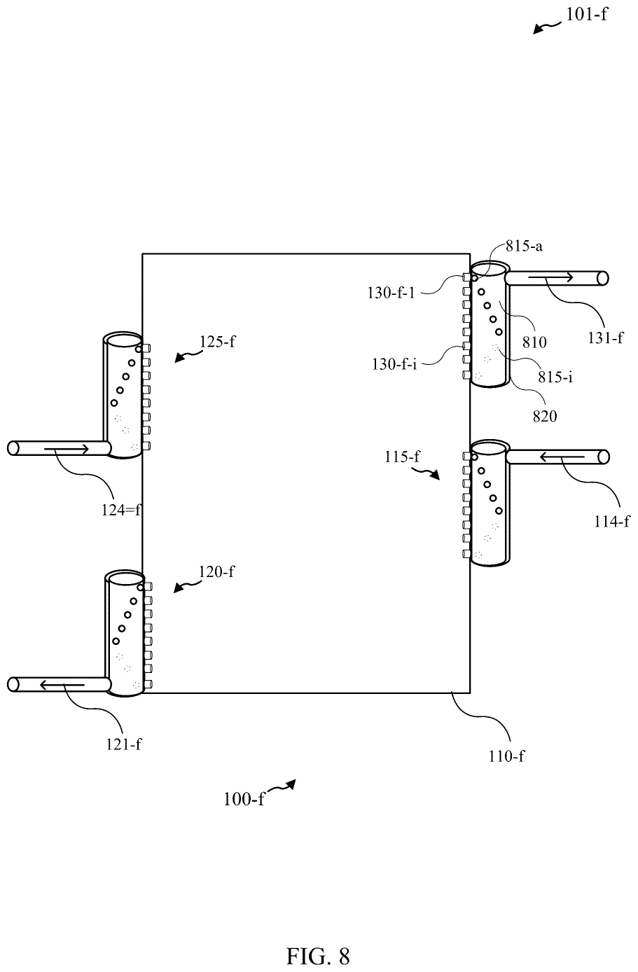

As suggested by the multiple vertically oriented double-headed arrows in FIG. 5, inlet port(s) 115-c, inlet port(s) 125-c, outlet port(s) 120-c, and/or outlet port(s) 130-c may be configured such that their positions may be altered to impact where the respective brines may be introduced into the tank 110-c and/or removed from tank 100-c. This may be achieved in a variety of ways, such as mechanically moving the inlet port(s) and/or outlet port(s) or through configuration of multiple inlet ports and/or outlet ports for each of these respective areas and then selectively opening and closing the respective inlet port(s) and/or outlet port(s). In some embodiments, the various inlet ports and/or outlet ports may be configured as pipes running down the side of the multi-zone tank device 100-c. Each pipe may include multiple apertures formed in a spiral around the pipe. The pipe may be rotated to align a respective opening in the pipe to either introduce or remove brine from the tank. The unaligned apertures may be blocked around the circumference utilizing an outer pipe in some cases. FIG. 8 shows a device 100-f with respect to aspects of a system 101-f in accordance with various embodiments that may show an example of such a construction with variable ports. While four variable pipe inlet ports and outlet ports are shown, specific reference numbers are called out with regard to outlet port(s) 130-f-1, . . . , 130-f-i, including inner pipe 810 with multiple apertures 815-a, . . . , 815-i and outer pipe 820. Device 100-f may also show outlet ports 130-f as multiple outlets ports 130-f-1, . . . , 130-f-i. In some embodiments, outlet ports 130-f may be configured as a vertical opening down multi-zone tank device 100-f such that the apertures 815 may align as the pipe 810 may be rotated; outer pipe 820 may also in general include a vertical opening to facilitate brine being removed through an aligned outlet port 130-f. Similar variable ports may be shown with respect to inlet ports 115-f, outlet ports 120-f, and inlet ports 125-f. System 101-f also shows first brine 114-f, second brine 121-f, third brine 124-f, and fourth brine 131-f. One or more loads (not shown) may be positioned with respect to second brine 121-f and third brine 124-f, though not shown here. A separator and/or recuperator (not shown) may be positioned with respect to fourth brine 131-f and first brine 114-f, though not shown here. Some embodiments of system 101-f include a solid maker (not shown).

Altering where brine may be delivered and/or removed from the multi-zone tank device 100-f may allow for various optimizations, such as controlling where brine is delivered or removed from multi-zone tank device 100-f such as to keep approximately equal amounts of solid, such as ice, in the upper zones(s) and the lower zone(s). For example, the various inlet ports 115-f, inlet ports 125-f, outlet ports 120-f, and/or outlet ports 130-f may be positioned (including possibly configured to vary) such that a substantial amount of solid (not shown), such as ice, may be in both the upper or top zone(s) and also the lower or bottom zone(s) of tank 110-f.

With respect to FIG. 1A, FIG. 1B, FIG. 2, FIG. 3, FIG. 4, FIG. 5, FIG. 6, FIG. 7, and/or FIG. 8, the use of multi-zone tank device 100 in accordance with various embodiments may address various challenges for freeze point suppression systems. For example, multi-zone tank device 100 may help balance ice or system efficiency with separation efficiency, which may be at odds with each other. Multi-zone tank device 100 may provide for mixing of solids, such as ice, and brine within the multi-zone tank device 100 through the flows of the solid and brines into and out of the multi-zone tank device 100, which may provide more control.

In general, the lower or bottom zone(s) of a multi-zone tank device 100 may provide for the mixing and melting steps of a freeze point suppression cycle with solids, such as ice, and concentrated brine combining. Embodiments can help optimize the value of the brine and solids that may maximize ice efficiency. The upper or top zone(s) may allow for the solids to cool down before going into the lower or bottom zone(s), while also cooling the brine that may be removed from the upper or top zone(s); this may be achieved through mixing relatively warm brine at moderate concentration with the solids, such as ice. The brine that may leave the multi-zone tank device 100 may generally be less concentrated than the moderate concentration of brine mixed with solids, such as ice, in the upper or top zone(s) of the multi-zone tank device 100.

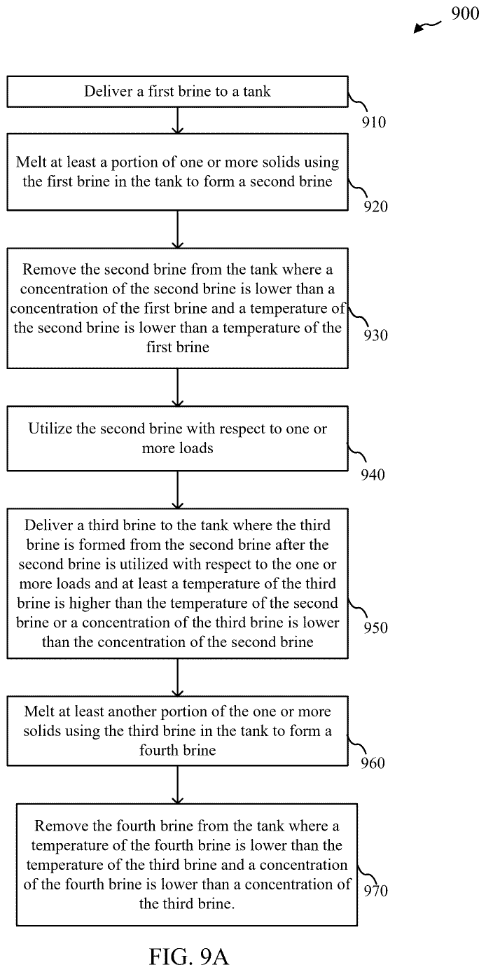

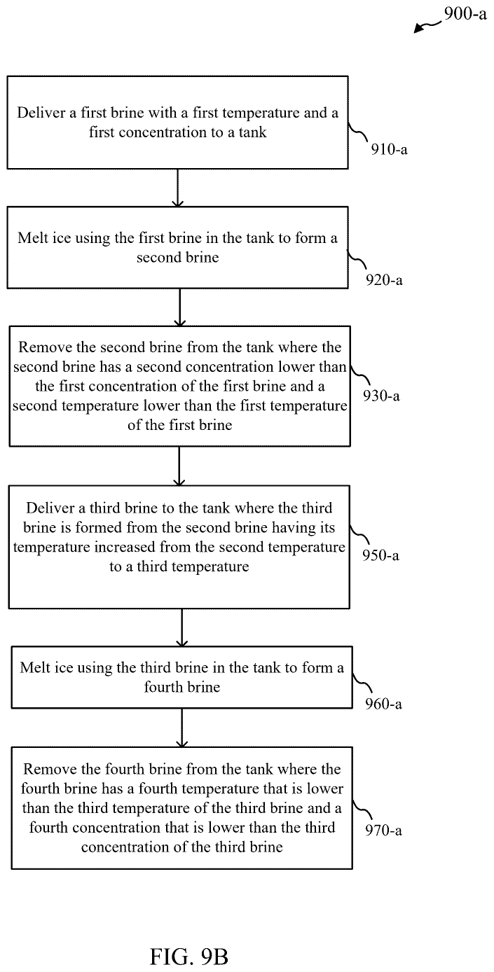

Turning to FIG. 9A, a flow diagram of a method 900 is shown in accordance with various embodiments. Method 900 may be implemented utilizing systems and/or devices as those shown in FIG. 1A, FIG. 1B, FIG. 2, FIG. 3, FIG. 4, FIG. 5, FIG. 6, FIG. 7, and/or FIG. 8.

At block 910, a first brine may be delivered to a tank. At block 920, at least a portion of one or more solids may be melted in the tank using the first brine in the tank to form a second brine. At block 930, the second brine may be removed from the tank; a concentration of the second brine may be lower than a concentration of the first brine and a temperature of the second brine may be lower than a temperature of the first brine. At block 940, the second brine may be utilized with respect to one or more loads. At block 950, a third brine may be delivered to the tank; the third brine may be formed from the second brine after the second brine is utilized with respect to the one or more loads; at least a temperature of the third brine may be higher than the temperature of the second brine or a concentration of the third brine may lower than the concentration of the second brine. At block 960, at least another portion of the one or more solids may be melted using the third brine in the tank to form a fourth brine. At block 970, the fourth brine from the tank may be removed; a temperature of the fourth brine may be lower than the temperature of the third brine and a concentration of the fourth brine may be lower than a concentration of the third brine.

In some embodiments the method 900, the first brine is delivered to the tank through one or more inlet ports for the first brine. The second brine may be removed from the tank using one or more outlet ports for the second brine. The one or more inlet ports for the first brine may be positioned higher in the tank than the one or more outlet ports for the second brine.

In some embodiments of the method 900, the third brine is delivered to the tank through one or more inlet ports for the third brine. The fourth brine may be removed from the tank using one or more outlet ports for the fourth brine. The one or more inlet ports for the first brine may be positioned lower in the tank than the one or more outlet ports for the fourth brine. The one or more outlet ports for the second brine may be positioned lower in the tank than the one or more inlet ports for the third brine.

In some embodiments of the method 900, the one or more inlet ports for the third brine are positioned higher in the tank than the one or more inlet ports for the first brine. In some embodiments, the one or more inlet ports for the third brine are positioned lower in the tank than the one or more outlet ports for the fourth brine. In some embodiments, the one or more inlet ports for the third brine are positioned higher in the tank than the one or more outlet ports for the fourth brine. In some embodiments, the one or more inlet ports for the third brine are positioned at least level with or lower in the tank than the one or more inlet ports for the first brine. In some embodiments, the one or more inlet ports for the third brine are positioned level in the tank with the one or more outlet ports for the fourth brine. In some embodiments, at least the one or more inlet ports for the first brine, the one or more outlet ports for the second brine, the one or more inlet ports for the third brine, or the one or more outlet ports for the fourth brine include one or more variable ports.

Some embodiments of the method 900 include removing a fifth brine from the tank. A temperature of the fifth brine may be lower than the temperature of the third brine and a concentration of the fifth brine may be lower than the concentration of the third brine. The temperature of the fifth brine may be different from the temperature of the fourth brine or the concentration of the fifth brine may be different from the concentration of the fourth brine.

Some embodiments of the method 900 further include delivering the fourth brine to a separator that forms the first brine from the fourth brine. Some embodiments include passing the fourth brine through a recuperator prior to delivering the fourth brine to the separator where the recuperator increases a temperature of the fourth brine through exchanging heat with the first brine delivered from the separator.

Turning to FIG. 9B, a flow diagram of a method 900 is shown in accordance with various embodiments. Method 900 may be implemented utilizing systems and/or devices as those shown in FIG. 1A, FIG. 1B, FIG. 2, FIG. 3, FIG. 4, FIG. 5, FIG. 6, FIG. 7, and/or FIG. 8. Method 900-a may be an example of method 900 of FIG. 9A.

At block 910-a, a first brine with a first temperature and a first concentration may be delivered to a tank. At block 920-a, ice may be melted using the first brine in the tank to form a second brine. At block 930-a, the second brine may be removed from the tank where the second brine has a second concentration lower than the first concentration of the first brine and a second temperature lower than the first temperature of the first brine. In some embodiments, the second brine may be utilized with respect to one or more loads. At block 950-a, a third brine may be delivered to the tank where the third brine is formed from the second brine having its temperature increased from the second temperature to a third temperature. At block 960-a, ice may be melted using the third brine in the tank to form a fourth brine. At block 970-a, the fourth brine may be removed from the tank where the fourth brine has a fourth temperature that is lower than the third temperature of the third brine and a fourth concentration that is lower than the third concentration of the third brine.

These embodiments may not capture the full extent of combination and permutations of materials and process equipment. However, they may demonstrate the range of applicability of the methods, devices, and/or systems. The different embodiments may utilize more or less stages than those described.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various stages may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the embodiments.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which may be depicted as a flow diagram or block diagram or as stages. Although each may describe the operations as a sequential process, many of the operations can be performed in parallel or concurrently. In addition, the order of the operations may be rearranged. A process may have additional stages not included in the figures.

Having described several embodiments, it will be recognized by those of skill in the art that various modifications, alternative constructions, and equivalents may be used without departing from the spirit of the different embodiments. For example, the above elements may merely be a component of a larger system, wherein other rules may take precedence over or otherwise modify the application of the different embodiments. Also, a number of stages may be undertaken before, during, or after the above elements are considered. Accordingly, the above description should not be taken as limiting the scope of the different embodiments.

1. A method comprising:
delivering a first brine to a tank;
melting at least a portion of one or more solids in the tank using the first brine in the tank to form a second brine;
removing the second brine from the tank, wherein a concentration of the second brine is lower than a concentration of the first brine and a temperature of the second brine is lower than a temperature of the first brine;
utilizing the second brine with respect to one or more loads;
delivering a third brine to the tank, wherein the third brine is formed from the second brine after the second brine is utilized with respect to the one or more loads and at least a temperature of the third brine is higher than the temperature of the second brine or a concentration of the third brine is lower than the concentration of the second brine;
melting at least another portion of the one or more solids using the third brine in the tank to form a fourth brine;
removing the fourth brine from the tank, wherein a temperature of the fourth brine is lower than the temperature of the third brine and a concentration of the fourth brine is lower than a concentration of the third brine.

2. The method of claim 1, wherein:
the first brine is delivered to the tank through one or more inlet ports for the first brine;
the second brine is removed from the tank using one or more outlet ports for the second brine; and
the one or more inlet ports for the first brine are positioned higher in the tank than the one or more outlet ports for the second brine.

3. The method of claim 2, wherein:
the third brine is delivered to the tank through one or more inlet ports for the third brine;
the fourth brine is removed from the tank using one or more outlet ports for the fourth brine;
the one or more inlet ports for the first brine are positioned lower in the tank than the one or more outlet ports for the fourth brine; and
the one or more outlet ports for the second brine are positioned lower in the tank than the one or more inlet ports for the third brine.

4. The method of claim 3, wherein the one or more inlet ports for the third brine are positioned higher in the tank than the one or more inlet ports for the first brine.

5. The method of claim 3, wherein the one or more inlet ports for the third brine are positioned lower in the tank than the one or more outlet ports for the fourth brine.

6. The method of claim 3, wherein the one or more inlet ports for the third brine are positioned higher in the tank than the one or more outlet ports for the fourth brine.

7. The method of claim 3, wherein the one or more inlet ports for the third brine are positioned at least level with or lower in the tank than the one or more inlet ports for the first brine.

8. The method of claim 3, wherein the one or more inlet ports for the third brine are positioned level in the tank with the one or more outlet ports for the fourth brine.

9. The method of claim 3, wherein at least the one or more inlet ports for the first brine, the one or more outlet ports for the second brine, the one or more inlet ports for the third brine, or the one or more outlet ports for the fourth brine include one or more variable ports.

10. The method of claim 1, further comprising removing a fifth brine from the tank, wherein:
a temperature of the fifth brine is lower than the temperature of the third brine and a concentration of the fifth brine is lower than the concentration of the third brine; and
at least the temperature of the fifth brine is different from the temperature of the fourth brine or the concentration of the fifth brine is different from the concentration of the fourth brine.

11. The method of claim 1, further comprising delivering the fourth brine to a separator that forms the first brine from the fourth brine.

12. The method of claim 11, further comprising passing the fourth brine through a recuperator prior to delivering the fourth brine to the separator, wherein the recuperator increases a temperature of the fourth brine through exchanging heat with the first brine delivered from the separator.

13. A device comprising:
a tank with a plurality of inlet ports and a plurality of outlet ports, wherein:
the plurality of inlet ports include one or more inlet ports positioned to deliver a first brine to the tank;
the tank is configured to melt at least a portion of one or more solids in the tank using the first brine in the tank to form a second brine;
the plurality of outlet ports include one or more outlet ports positioned to remove the second brine from the tank, wherein a concentration of the second brine is lower than a concentration of the first brine and a temperature of the second brine is lower than a temperature of the first brine;
the plurality of inlet ports include one or more inlet ports positioned to deliver a third brine to the tank, wherein the third brine is formed from the second brine after the second brine is utilized with respect to one or more loads and at least a temperature of the third brine is higher than the temperature of the second brine or a concentration of the third brine is lower than the concentration of the second brine;
the tank is further configured to melt at least an additional portion of the one or more solids using the third brine in the tank to form a fourth brine; and
the plurality of outlet ports include one or more outlet ports positioned to remove the fourth brine from the tank, wherein a temperature of the fourth brine is lower than the temperature of the third brine and a concentration of the fourth brine is lower than the concentration of the third brine.

14. The device of claim 13, wherein the one or more inlet ports positioned to deliver the first brine are positioned higher in the tank than the one or more outlet ports positioned to remove the second brine.

15. The device of claim 14, wherein:
the one or more inlet ports positioned to deliver the first brine are positioned lower in the tank than the one or more outlet ports positioned to remove the fourth brine; and
the one or more outlet ports positioned to remove the second brine are positioned lower in the tank than the one or more inlet ports positioned to deliver the third brine.

16. The device of claim 15, wherein the one or more inlet ports positioned to deliver the third brine are positioned higher in the tank than the one or more inlet ports positioned to deliver the first brine.

17. The device of claim 15, wherein the one or more inlet ports positioned to deliver the third brine are positioned lower in the tank than the one or more outlet ports positioned to remove the fourth brine.

18. The device of claim 15, wherein the one or more inlet ports positioned to deliver third brine are positioned higher in the tank than the one or more outlet ports positioned to remove the fourth brine.

19. The device of claim 15, wherein the one or more inlet ports positioned to deliver the third brine are positioned at least level with or lower in the tank than the one or more inlet ports positioned to deliver the first brine.

20. The device of claim 15, wherein the one or more inlet ports positioned to deliver the third brine are positioned level in the tank with the one or more outlet ports positioned to remove the fourth brine.

21.-36. (canceled)
